(19) United States
(12) Patent Application Publication
(10) Pub. No.: US 2011/0260565 A1
(43) Pub. Date: Oct. 27, 2011

(54) ALLOY MATERIAL FOR R-T- B SYSTEM RARE EARTH PERMANENT MAGNET, METHOD FOR PRODUCTION OF R-T-B SYSTEM RARE EARTH PERMANENT MAGNET, AND MOTOR

(75) Inventor: Kenichiro Nakajima, Chichibu-shi (JP)

(73) Assignee: SHOWA DENKO K.K., Minato-ku, Tokyo (JP)

(21) Appl. No.: 13/141,905

(22) PCT Filed: Dec. 14, 2009
(86) PCT No.: PCT/JP2009/006851

§ 371 Date: Jun. 23, 2011

(30) Foreign Application Priority Data
Dec. 26, 2008 (JP) 2008-334438

(51) Int. Cl. B22F 3/12; H02K 21/00; B22F 1/00

(52) U.S. Cl. 310/152; 419/10; 75/252; 75/254

(57) ABSTRACT

An alloy material for an R-T-B based rare earth permanent magnet of the present invention includes: an R-T-B based alloy that comprises R, T, and B (wherein R represents at least one selected from the group consisting of Nd, Pr, Dy, and Tb, with Dy or Tb being essentially contained at 4% by mass to 10% by mass in the R-T-B type alloy; T represents a transition metal which essentially contains Fe; and B represents boron, a part of which can be substituted by carbon or nitrogen); and a high melting point compound having a melting point of 1080° C. or higher.

### TECHNICAL FIELD

The present invention relates to an alloy material for an R-T-B based rare earth permanent magnet, a process for producing an R-T-B based rare earth permanent magnet, and a motor, and particularly to an alloy material for an R-T-B based rare earth permanent magnet which enables the production of an R-T-B based rare earth permanent magnet that has excellent magnetic properties and can be suitably used for a motor, a process for producing an R-T-B based rare earth permanent magnet using the same, and a motor using the same.

Priority is claimed on Japanese Patent Application No. 2008-334438, filed Dec. 26, 2008, the content of which is incorporated herein by reference.

### BACKGROUND ART

Heretofore, R-T-B based magnets have been used for various types of motors and such devices, and an internal permanent magnet having an R-T-B based magnet assembled within a motor is known to be much more efficient than conventional types of motors. A recent increase in demand for energy saving, in addition to enhancements in the heat resistance of the R-T-B based magnets, has caused the usage rate in motors, including automobile motors, to increase.

The R-T-B based magnet is a kind of magnet that has Nd, Fe, and B, as main components. In the alloy of the R-T-B based magnet, the symbol R refers to Nd a part of which is substituted by another type of rare earth element such as Pr, Dy, and Tb. The symbol T refers to Fe a part of which is substituted by another type of transition metal such as Co and Ni. The symbol B refers to boron a part of which can be substituted by C or N.

Regarding the material for use in such an R—Fe—B based rare earth permanent magnet, there has been provided an RFeB based magnet alloy composed of an R₂Fe₁₄B phase accounting for 87.5 to 97.5% by volume as a main phase component (wherein R represents at least one type of rare earth element), and either a rare earth element, or a rare earth element and a transition metal oxide, accounting for 0.1 to 3% by volume, in which a compound selected from a ZrB compound comprising Zr and B, an NbB compound comprising Nb and B, and an HfB compound comprising Hf and B, as a main component, is homogeneously dispersed in the metallic structure of the above-mentioned alloy, the average grain diameter of the compound is 5 μm or smaller, and the maximum interval between adjacent grains of the compound in the alloy is 50 μm (for example, refer to Patent Document 1).

In addition, regarding the material for use in the R—Fe—B based rare earth permanent magnet, there has also been provided an R—Fe—Co—B—Al—Cu type rare earth permanent magnet (wherein R represents one or two or more types of elements selected from Nd, Pr, Dy, Tb, and Ho, with the Nd content accounting for 15 to 33% by mass) in which at least two types of compounds selected from an M-B based compound, an M-B—Cu based compound, and an M-C based compound (M represents one or two or more types of elements selected from Ti, Zr, and Hf), and an R oxide, are deposited in the alloy structure (for example, refer to Patent Document 2).

### CITATION LIST

### Patent Literature

### [Patent Literature 1]

Japanese Patent (Granted) Publication No. 3951099

### [Patent Literature 2]

Japanese Patent (Granted) Publication No. 3891307

### SUMMARY OF INVENTION

### Technical Problem

However, in recent years, R-T-B based rare earth permanent magnets having much higher performances are required. Specifically speaking, 30 kOe or higher coercivity is demanded for application to a motor.

As a method for improving the coercivity of an R-T-B based rare earth permanent magnet, a method to increase the Dy concentration in the R-T-B based alloy can be considered. As the Dy concentration in the R-T-B based alloy is increased, the higher coercivity (Hcj) can be given to the rare earth permanent magnet after sintering. However, there is a problem in that the remanence (Br) is lowered when the Dy concentration in the R-T-B based alloy is increased. On the other hand, it is possible to improve the lowering of the remanence while improving the coercivity, if Tb is used instead of Dy. However, it is difficult to adopt Tb in practice because Tb is expensive and limited in terms of resources.

For these reasons, in prior art, it has been difficult to sufficiently increase the coercivity and like magnetic properties of R-T-B based rare earth permanent magnets.

The present invention takes into consideration the above circumstances with an object of providing an alloy material for an R-T-B type rare earth permanent magnet which enables the production of an R-T-B type rare earth permanent magnet having high coercivity without lowering the remanence, and a process for producing an R-T-B type rare earth permanent magnet using the same.

Moreover, it is also an object to provide a motor using the R-T-B type rare earth permanent magnet having excellent magnetic properties that has been produced by the process for producing an R-T-B type rare earth permanent magnet mentioned above.

### Solution to Problem

The inventors of the present invention conducted investigations on the relation between an R-T-B based alloy and the magnetic properties of a rare earth permanent magnet produced by using this alloy. Then, the inventors of the present invention discovered that, when producing a rare earth permanent magnet by sintering a Dy-containing R-T-B based alloy, it is possible, by preparing an alloy material for a permanent magnet by mixing the R-T-B based alloy and a high melting point compound having a melting point equal to or higher than the sintering temperature (for example, 1080° C. or higher), and by making the R-T-B based rare earth permanent magnet by molding and sintering this alloy material, to achieve high coercivity (Hcj) without increasing the Dy concentration in the R-T-B based alloy, and, furthermore, to suppress the lowering of the remanence (Br) due to the addition of Dy. This has led to the completion of the present invention.

This effect is possibly attained, in the case where an alloy material for a permanent magnet is prepared by mixing an R-T-B based alloy and a high melting point compound having a melting point of 1080° C. or higher and this alloy material is molded and sintered, due to the high melting point compound reacting with a rare earth element constituting the magnetic phase or the grain boundary, or with Al, Ga, B, or C, or a trace amount of another type of metal contained in the alloy, during the sintering process, thereby producing a reaction product, and a part of the reaction product covering the surfaces of particles of the main phase very thinly so that the migration of magnetic domains can be hindered, and by so doing the coercivity is improved.

That is, the present invention provides the following inventive aspects.

(1) An alloy material for an R-T-B based rare earth permanent magnet, comprising: an R-T-B based alloy that comprises R, T, and B (wherein R represents at least one selected from the group consisting of Nd, Pr, Dy, and Tb, with Dy or Tb being essentially contained at 4% by mass to 10% by mass in the R-T-B based alloy; T represents a transition metal which essentially contains Fe; and B represents boron, a part of which can be substituted by carbon or nitrogen); and a high melting point compound having a melting point of 1080° C. or higher.
(2) An alloy material for an R-T-B based rare earth permanent magnet according to (1), wherein the high melting point compound includes an oxide, a boride, a carbide, a nitride, or a silicide of any one selected from the group consisting of Al, Ga, Mg, Nb, Si, Ti, and Zr.
(3) An alloy material for an R-T-B based rare earth permanent magnet according to either one of (1) and (2), wherein the high melting point compound includes any one selected from the group consisting of AlN, Al₂O₃, BN, Ga₂O₃, LaSi₂, MgO, NbB₂, NbO₂, SiC, TiO₂, TiB₂, TiC, TiN, ZrO₂, ZrN, ZrC, and ZrB₂.
(4) An alloy material for an R-T-B based rare earth permanent magnet according to any one of (1) to (3), wherein the high melting point compound is contained at 0.002% by mass to 2% by mass.
(5) An alloy material for an R-T-B based rare earth permanent magnet according to any one of (1) to (4), which is a mixture of a powder made of the R-T-B based alloy and a powder made of the high melting point compound.
(6) A process for producing an R-T-B based rare earth permanent magnet, comprising molding and sintering the alloy material for an R-T-B based rare earth permanent magnet according to any one of (1) to (5).
(7) A motor comprising an R-T-B based rare earth permanent magnet that has been produced by the process for producing an R-T-B based rare earth permanent magnet according to (6).

### Advantageous Effects of Invention

The alloy material for an R-T-B based rare earth permanent magnet of the present invention includes: an R-T-B based alloy that comprises R, T, and B (wherein: R represents at least one element selected from the group consisting of Nd, Pr, Dy, and Tb, with Dy or Tb being essentially contained at 4% by mass to 10% by mass in the R-T-B based alloy; T represents a transition metal which essentially contains Fe; and B represents boron, a part of which can be substituted by carbon or nitrogen); and a high melting point compound having a melting point of 1080° C. or higher. Thus, it becomes possible, by making an R-T-B based rare earth permanent magnet by molding and sintering this alloy material, to achieve sufficiently high coercivity (Hcj) without increasing the Dy concentration in the R-T-B based alloy, furthermore, to suppress the lowering of the remanence (Br) and like magnetic properties due to the addition of Dy, and to realize an R-T-B based rare earth permanent magnet that has excellent magnetic properties and can be suitably used for a motor.

### BRIEF DESCRIPTION OF DRAWINGS

FIG. 1 is a photograph showing the results of an R-T-B based rare earth permanent magnet of the present invention, analyzed by an electron probe micro analyzer.

FIG. 2 is another photograph showing the results of the R-T-B based rare earth permanent magnet of the present invention, analyzed by the electron probe micro analyzer.

### DESCRIPTION OF EMBODIMENTS

Hereunder is a description of embodiments of the present invention with reference to the drawings.

The alloy material for an R-T-B based rare earth permanent magnet of the present invention (hereunder, abbreviated to “permanent magnet alloy material”) includes an R-T-B based alloy and a high melting point compound having a melting point of 1080° C. or higher.

In the R-T-B based alloy constituting the permanent magnet alloy material of this embodiment, the symbol R represents at least one element selected from the group consisting of Nd, Pr, Dy, and Tb, with Dy or Tb being essentially contained at 4% by mass to 10% by mass in the R-T-B based alloy, the symbol T represents a transition metal which essentially contains Fe, and the symbol B represents boron, a part of which can be substituted by carbon or nitrogen.

Regarding the composition of the R-T-B based alloy, R accounts for 27 to 33% by mass and preferably 30 to 32% by mass, B accounts for 0.85 to 1.3% by mass and preferably 0.87 to 0.98% by mass, and the other components including T and inevitable impurities account for the balance.

If R constituting the R-T-B based alloy accounts for lower than 27% by mass, the coercivity may be insufficient. If R accounts for higher than 33% by mass, the remanence may be insufficient.

The rare earth elements other than Dy to be contained in R of the R-T-B based alloy can be exemplified by Sc, Y, La, Ce, Pr, Nd, Pm, Sm, Eu, Gd, Tb, Ho, Er, Tm, Yb, and Lu. Of these, it is particularly preferable to use Nd, Pr, and Tb, and it is preferable to use Nd as a main component.

The Dy content in the R-T-B based alloy is from 4% by mass to 10% by mass, preferably from 6% by mass to 9.5% by mass, and more preferably from 7% by mass to 9.5% by mass. If the Dy content in the R-T-B based alloy exceeds 10% by mass, the lowering of the remanence (Br) becomes outstanding, making it insufficient for application to a motor. Moreover, if the Dy content in the R-T-B based alloy is lower than 4% by mass, the coercivity of a rare earth permanent magnet produced by using this alloy becomes insufficient for application to a motor.

T included in the R-T-B based alloy refers to a transition metal which essentially contains Fe and which can also contain another type of transition metal such as Co and Ni, in addition to Fe. It is preferable if Co is contained in addition to Fe, because the Tc (Curie temperature) can be improved.

Moreover, if B constituting the R-T-B based alloy accounts for lower than 0.85% by mass, the coercivity may be insufficient. If B accounts for higher than 1.3% by mass, the remanence may be lowered, making it insufficient for application to a motor.

B included in the R-T-B based alloy refers to boron, a part of which can be substituted by C or N.

In addition, it is preferable that Al, Cu, or Ga is contained in the R-T-B based alloy so as to improve the coercivity.

It is more preferable that Ga is contained at 0.03% by mass to 0.3% by mass. It is preferable if the Ga content is 0.03% by mass or higher, because the coercivity can be effectively improved. However, it is not preferable that the Ga content exceeds 0.3% by mass, because the remanence is lowered.

Furthermore, it is preferable that the oxygen concentration in the permanent magnet alloy material is as low as possible. If the oxygen content is from 0.03% by mass to 0.5% by mass, and more specifically from 0.05% by mass to 0.2% by mass, sufficient magnetic properties for application to a motor can be achieved. Note that the magnetic properties may be remarkably lowered if the oxygen content exceeds 0.5% by mass.

Moreover, it is preferable that the carbon concentration in the permanent magnet alloy material is as low as possible. If the carbon content is from 0.003% by mass to 0.5% by mass, and more specifically from 0.005% by mass to 0.2% by mass, sufficient magnetic properties for application to a motor can be achieved. Note that the magnetic properties may be remarkably lowered if the carbon content exceeds 0.5% by mass.

In addition, it is preferable that the permanent magnet alloy material is a mixture of a powder made of the R-T-B based alloy and a powder made of the high melting point compound.

The average grain size of the powder made of the R-T-B based alloy is preferably from 3 to 4.5 μm.

Moreover, the grain size distribution (cumulative volume frequency) of the powder made of the high melting point compound is preferably within a range from 0.3 to 4.4 μm for d10, from 1 to 9.5 μm for d50, and from 2.3 to 15 μm for d90.

Furthermore, as the high melting point compound, a compound having a melting point of 1080° C. or higher is used, and it is preferable to use a non-magnetic compound having a melting point of 1800° C. or higher. Specifically speaking, such preferred high melting point compounds can be exemplified by oxides, borides, carbides, nitrides, and silicides of group III, group IV, group V, and group XIII elements, and solid solutions and mixtures thereof. Of these, preferred are oxides, borides, carbides, nitrides, and silicides of any one element selected from the group consisting of Al, Ga, Mg, Nb, Si, Ti, and Zr, and solid solutions and mixtures thereof. In particular, more preferred is any one compound selected from the group consisting of AlN (having a melting point of 2200° C.), Al₂O₃ (having a melting point of 2054° C.), BN (having a melting point of 3000° C.), Ga₂O₃ (having a melting point of 1900° C.), LaSi₂ (having a melting point of 1800° C.), MgO (having a melting point of 2826° C.), NbB₂ (having a melting point of 3050° C.), NbO₂ (having a melting point of 1902° C.), SiC (having a melting point of 2700° C.), TiO₂ (having a melting point of 1843° C.), TiB₂ (having a melting point of 2920° C.), TiC (having a melting point of 3157° C.), TiN (having a melting point of 2950° C.), ZrO₂ (having a melting point of 2715° C.), ZrN (having a melting point of 2980° C.), ZrC (having a melting point of 3540° C.), and ZrB₂ (having a melting point of 3000° C.).

The content of the high melting point compound in the permanent magnet alloy material is preferably from 0.002% by mass to 2% by mass, more preferably from 0.05% by mass to 1.0% by mass, and yet more preferably from 0.1% by mass to 0.7% by mass. If the content of the high melting point compound is lower than 0.002% by mass, excessive sintering of the R-T-B based rare earth permanent magnet may be so suppressed that the effect to improve the coercivity (Hcj) can not be sufficiently achieved. Moreover, it is not preferable if the content of the high melting point compound exceeds 2% by mass, because the remanence (Br), the maximum energy product (BHmax), and like magnetic properties are remarkably lowered.

The permanent magnet alloy material of the present invention can be prepared by mixing the R-T-B based alloy and the high melting point compound. However, preferably, the permanent magnet alloy material is prepared by a process in which a powder made of the R-T-B based alloy and a powder made of the high melting point compound are mixed.

Such a powder made of the R-T-B based alloy can be obtained by, for example, a process in which a molten alloy is cast by a SC (Strip Casting) method to produce cast alloy flakes, and the thus obtained cast alloy flakes are decrepitated by, for example, a hydrogen decrepitation method and then pulverized by a pulverizer, or such a process.

The hydrogen decrepitation method can be exemplified by a method in which hydrogen is stored in cast alloy flakes at room temperature and these flakes are subjected to heat treatment at a temperature of about 300° C., hydrogen is then degassed by reducing the pressure, and thereafter hydrogen inside the cast alloy flakes is removed by heat treatment at a temperature of about 500° C. In the hydrogen decrepitation method, because the volumes of the cast alloy flakes that are storing hydrogen are expanded, a large number of cracks can be easily generated inside the alloy and thus the alloy flakes are decrepitated.

Moreover, the method for pulverizing the hydrogen-decrepitated cast alloy flakes can be exemplified by a method in which the hydrogen-decrepitated cast alloy flakes are finely pulverized into a powder having an average grain size of 3 to 4.5 μm by a pulverizer such as a jet mill with high pressure nitrogen at 0.6 MPa, for example.

The process for producing an R-T-B based rare earth permanent magnet with use of the thus obtained permanent magnet alloy material can be exemplified by a process in which, for example, the permanent magnet alloy material is added with 0.03% by mass of zinc stearate as a lubricant, press-molded by using a perpendicular alignment pressing machine, sintered in a vacuum at 1030° C. to 1080° C., and then heat treated at 400° C. to 800° C., thereby making the R-T-B based rare earth permanent magnet.

The above-mentioned example describes a case where the R-T-B based alloy is prepared by the SC method. However, the R-T-B based alloy for use in the present invention is not limited to one prepared by the SC method. For example, the R-T-B based alloy can be cast by a centrifugal casting method, a book molding method, or the like.

Moreover, the R-T-B based alloy and the high melting point compound can be mixed after making the powder made of the R-T-B based alloy, by pulverizing the cast alloy flakes as mentioned above. However, it is also possible, for example, to make the permanent magnet alloy material by mixing the cast alloy flakes and the high melting point compound before pulverizing the cast alloy flakes, and thereafter pulverizing the permanent magnet alloy material. The high melting point compound is not limited to the form of powder and may be in an equivalent size to that of the cast alloy flakes. In this case, it is preferable that the permanent magnet alloy material consisting of the cast alloy flakes and the high melting point compound are pulverized into a powder in the same manner as the method for pulverizing the cast alloy flakes, and thereafter the powder is molded and sintered in the same manner as the above-mentioned manner to thereby produce the R-T-B based rare earth permanent magnet.

In addition, the R-T-B based alloy and the high melting point compound can also be mixed after adding a lubricant such as zinc stearate to the powder made of the R-T-B based alloy.

The high melting point compound may be, or may not be, finely and homogeneously distributed in the permanent magnet alloy material of the present invention. For example, even if the high melting point compound has a grain size of 1 μm or larger, or is aggregated to form aggregates of 5 μm or larger, the effect can be demonstrated. In addition, the effect to improve the coercivity achieved by the present invention increases as the Dy concentration becomes higher, and a much greater effect can be realized if Ga is contained.

The R-T-B based rare earth permanent magnet produced by molding and sintering the permanent magnet alloy material of this embodiment has high coercivity (Hcj) and is suitable as a magnet for a motor which should have sufficiently high remanence (Br).

The coercivity (Hcj) of the R-T-B based rare earth permanent magnet is preferably as high as possible. For application to a magnet in a motor, 30 kOe or higher coercivity is preferred. If the coercivity (Hcj) of a magnet in a motor is lower than 30 kOe, the heat resistance as a motor may be insufficient.

Moreover, the remanence (Br) of the R-T-B based rare earth permanent magnet is preferably as high as possible. For application to a magnet in a motor, 10.5 kG or higher remanence is preferred. If the remanence (Br) of the R-T-B based rare earth permanent magnet is lower than 10.5 kG, the magnet is not preferable as a magnet in a motor because the torque of the motor may be insufficient.

The permanent magnet alloy material of this embodiment includes: an R-T-B based alloy that comprises R, T, and B (wherein: R represents at least one element selected from the group consisting of Nd, Pr, Dy, and Tb, with Dy or Tb being essentially contained at 4% by mass to 10% by mass in the R-T-B based alloy; T represents a transition metal which essentially contains Fe; and B represents boron, a part of which can be substituted by carbon or nitrogen); and a high melting point compound having a melting point of 1080° C. or higher. Thus, it becomes possible, by making an R-T-B based rare earth permanent magnet by molding and sintering this alloy material, to achieve sufficiently high coercivity (Hcj) without increasing the Dy concentration in the R-T-B based alloy, furthermore, to suppress the lowering of the remanence (Br) and like magnetic properties due to the addition of Dy, and to realize an R-T-B based rare earth permanent magnet that has excellent magnetic properties and can be suitably used for a motor.

Specifically speaking, by using a permanent magnet alloy material which includes such a high melting point compound, it becomes possible to produce, for example, an R-T-B based rare earth permanent magnet whose the Dy content in the R-T-B based alloy is 7% by mass, but nonetheless, whose coercivity (Hcj) is equivalent to that of an R-T-B based rare earth permanent magnet which does not include any high melting point compound and whose Dy content in the R-T-B based alloy is 9.5% by mass.

In addition, for example, when comparing R-T-B based rare earth permanent magnets produced from materials including and not including a high melting point compound, provided that the Dy content in the R-T-B based alloy is 9.5% by mass, the coercivity (Hcj) is higher in the magnet including the high melting point compound whereas the remanence (Br) and the maximum energy product (BHmax) are equivalent in both cases.

Moreover, if the permanent magnet alloy material of this embodiment is a mixture of a powder made of the R-T-B based alloy and a powder made of the high melting point compound, it is readily possible to prepare a permanent magnet alloy material of uniform quality, and also it is readily possible, by molding and sintering this alloy material, to produce R-T-B based rare earth permanent magnets of uniform quality.

Furthermore, the process for producing an R-T-B based rare earth permanent magnet of this embodiment is a process in which the R-T-B based rare earth permanent magnet is produced by molding and sintering the permanent magnet alloy material of this embodiment. Therefore, it is possible to produce an R-T-B based rare earth permanent magnet that has excellent magnetic properties and can be suitably used for a motor.

### EXAMPLES

### Experimental Example 1

Permanent magnet alloy materials were prepared by adding a powder made of a high melting point compound having the grain size as shown in Table 2, to a powder made of an R-T-B based alloy (alloy A to alloy D) having the component composition and the average grain size as shown in Table 1, at ratios shown in Table 3 or Table 4 (concentrations (% by mass) of high melting point compounds contained in the permanent magnet alloy materials).

The powder made of the R-T-B based alloy was produced by the following method. First, a molten alloy of the component composition as shown in Table 1 was cast by a SC (Strip Casting) method, thereby producing cast alloy flakes. Next, hydrogen was stored in the thus produced cast alloy flakes at room temperature, and these flakes were subjected to heat treatment at a temperature of about 300° C. Hydrogen was then degassed by reducing the pressure, and thereafter hydrogen inside the cast alloy flakes was removed by heat treatment at a temperature of about 500° C. By so doing, hydrogen decrepitation was carried out. Subsequently, the hydrogen-decrepitated cast alloy flakes were finely pulverized into a powder having the average grain size as shown in Table 1 by a jet mill with high pressure nitrogen at 0.6 MPa.

The grain size of the powder made of the high melting point compound was measured by a laser diffractometer.

TABLE 1

| | | | | | | | | | | | | | Average |
|---|---|---|---|---|---|---|---|---|---|---|---|---|---|
| | Thickness | Component (wt %) | | | | | | | | | | | grain size |
| | (mm) | Nd | Pr | Dy | B | Al | Co | Cu | Ga | C | O | Fe | d50 (μm) |
| Alloy A | 0.29 | 17.0 | 6.0 | 9.5 | 0.90 | 0.1 | 1.0 | 0.1 | 0.08 | 0.012 | 0.013 | Balance | 4.5 |
| Alloy B | 0.30 | 20.0 | 6.0 | 4.5 | 0.90 | 0.1 | 1.0 | 0.1 | 0.08 | 0.012 | 0.013 | Balance | 4.5 |
| Alloy C | 0.30 | 18.4 | 6.0 | 7.5 | 0.90 | 0.1 | 1.0 | 0.1 | 0.08 | 0.012 | 0.013 | Balance | 4.5 |
| Alloy D | 0.30 | 18.0 | 6.0 | 6.9 | 0.90 | 0.1 | 1.0 | 0.1 | 0.08 | 0.012 | 0.013 | Balance | 4.5 |

TABLE 2

| | d50 (μm) |
|---|---|
| B₂O₃ | 50.00 |
| Al₂O₃ | 9.48 |
| MgO | 3.02 |
| TiAl | 170.41 |
| TiB₂ | 2.49 |
| TiC | 1.04 |
| TiN | 2.89 |
| TiO₂ | 2.50 |
| ZrB₂ | 3.13 |
| ZrO₂ | 4.28 |
| NbB₂ | 1.31 |
| LaSi | 19.35 |
| Ga₂O₃ | 2.83 |
| Al₂O₃ (HP) | 9.52 |
| AIN | 1.44 |

TABLE 3

| | High | | | | | |
|---|---|---|---|---|---|---|
| | melting point | | Hcj | Br | SR | BHmax |
| | compound | Dosage | (kOe) | (kG) | (%) | (MGOe) |
| Alloy A | Not contained | Not | 28.24 | 11.53 | 92.69 | 32.66 |
| | | contained | | | | |
| | B₂O₃ | 0.200% | 28.72 | 11.32 | 89.05 | 30.58 |
| | Al₂O₃ | 0.010% | 30.28 | 11.41 | 89.86 | 31.78 |
| | | 0.200% | 31.33 | 11.42 | 90.09 | 32.06 |
| | | 0.300% | 31.32 | 11.35 | 91.93 | 31.50 |
| | | 0.400% | 32.77 | 11.31 | 90.20 | 31.16 |
| | MgO | 0.010% | 30.21 | 11.39 | 89.69 | 31.67 |
| | | 0.050% | 31.52 | 11.26 | 88.21 | 30.98 |
| | | 0.100% | 30.95 | 11.42 | 87.66 | 31.77 |
| | | 0.200% | 32.30 | 11.33 | 87.53 | 31.46 |
| | TiAl | 0.050% | 33.06 | 11.18 | 86.21 | 30.42 |
| | TiB₂ | 0.200% | 30.00 | 11.22 | 83.65 | 30.04 |
| | TiC | 0.002% | 30.31 | 11.40 | 90.09 | 31.75 |
| | | 0.010% | 29.72 | 11.54 | 90.26 | 32.56 |
| | | 0.100% | 32.83 | 11.39 | 84.89 | 31.20 |
| | | 0.200% | 31.83 | 11.48 | 89.81 | 32.13 |
| | | 0.600% | 33.36 | 11.13 | 89.83 | 30.30 |
| | | 1.000% | 33.86 | 11.08 | 89.02 | 30.05 |
| | | 1.600% | 32.97 | 10.94 | 89.66 | 29.43 |
| | | 2.000% | 32.25 | 10.78 | 88.53 | 28.51 |
| | TiN | 0.010% | 30.52 | 11.19 | 87.70 | 30.40 |
| | | 0.050% | 30.73 | 11.21 | 86.87 | 30.43 |
| | | 0.200% | 33.06 | 11.44 | 90.23 | 32.04 |
| | TiO₂ | 0.100% | 30.94 | 11.39 | 91.14 | 31.94 |
| | | 0.200% | 33.40 | 11.37 | 86.45 | 31.45 |
| | ZrB₂ | 0.200% | 29.11 | 11.43 | 91.13 | 31.89 |
| | | 0.400% | 29.29 | 11.44 | 89.97 | 31.82 |
| | ZrO₂ | 0.050% | 30.31 | 11.27 | 89.37 | 30.91 |
| | | 0.100% | 33.43 | 11.42 | 88.05 | 31.73 |
| | | 0.200% | 32.33 | 11.34 | 91.12 | 31.76 |
| | NbB₂ | 0.200% | 28.28 | 11.37 | 88.88 | 31.23 |

TABLE 4

| | High melting | | | | | |
|---|---|---|---|---|---|---|
| | point | | Hcj | Br | SR | BHmax |
| | compound | Dosage | (kOe) | (kG) | (%) | (MGOe) |
| Alloy B | Not | Not contained | 22.94 | 12.81 | 94.39 | 39.67 |
| | contained | | | | | |
| | Al₂O₃ | 0.050% | 23.61 | 12.96 | 94.96 | 40.66 |
| | | 0.200% | 23.30 | 12.61 | 95.24 | 38.64 |
| | | 0.400% | 20.85 | 12.52 | 93.04 | 37.82 |
| | TiB₂ | 0.200% | 21.79 | 12.58 | 93.51 | 38.48 |
| | TiC | 0.050% | 23.02 | 12.76 | 94.90 | 39.60 |
| | | 0.200% | 23.32 | 12.61 | 93.22 | 38.63 |
| | | 1.000% | 23.62 | 12.22 | 92.44 | 36.26 |
| | TiN | 0.200% | 23.70 | 12.60 | 94.78 | 38.56 |
| | | 1.000% | 20.91 | 11.56 | 84.18 | 28.29 |
| | TiO₂ | 0.200% | 21.77 | 12.41 | 92.95 | 37.18 |
| | ZrO₂ | 0.200% | 23.37 | 12.52 | 94.58 | 38.07 |
| Alloy C | Not | Not contained | 27.10 | 12.27 | 92.54 | 36.76 |
| | contained | | | | | |
| | TiC | 0.200% | 28.80 | 11.66 | 90.09 | 33.21 |
| Alloy D | Not | Not contained | 28.23 | 12.02 | 89.68 | 34.08 |
| | contained | | | | | |
| | TiC | 0.200% | 28.49 | 11.83 | 91.95 | 34.14 |

Next, the thus prepared permanent magnet alloy material was added with 0.03% by mass of zinc stearate as a lubricant, press-molded by using a perpendicular alignment pressing machine, sintered in a vacuum at 1080° C. or lower temperature, and then heat treated at 400° C. to 800° C., thereby producing respectively five R-T-B based rare earth permanent magnets per each alloy material.

In addition, another five R-T-B based rare earth permanent magnets were respectively produced in the same manner as the above-mentioned manner, using the powder made of the R-T-B based alloy (alloy A to alloy D) having the component composition and the grain size as shown in Table 1, but without adding the powder made of the high melting point compound thereto.

Then, the magnetic properties of the respective R-T-B based rare earth permanent magnets produced by using the permanent magnet alloy materials including the high melting point compound and by using the permanent magnet alloy materials not including the high melting point compound were measured by a BH curve tracer. The results are shown in Table 3 and Table 4.

In Table 3 and Table 4, the symbol “Hcj” denotes the coercivity, the symbol “Br” denotes the remanence, the symbol “SR” denotes the squareness ratio, and the symbol “BHmax” denotes the maximum energy product. In addition, each value of these magnetic properties is the average of the measurement results of the five R-T-B based rare earth permanent magnets respectively.

As shown in Table 3, the R-T-B based rare earth permanent magnets produced by using the permanent magnet alloy material including the R-T-B based alloy (alloy A) and the high melting point compound showed higher coercivity (Hcj) as compared to the R-T-B based rare earth permanent magnets produced by using the permanent magnet alloy material including the alloy A but not including the high melting point compound. From these results, it was found to be possible, by using a permanent magnet alloy material including a high melting point compound, to improve the coercivity without increasing the Dy dosage.

Moreover, as shown in Table 3 and Table 4, when comparing the coercivity among the R-T-B based rare earth permanent magnets produced by using the permanent magnet alloy materials including the R-T-B based alloy (alloy A to alloy D) and 0.2% by mass of TiC as a high melting point compound, it was found that the coercivity increased with greater amplitude as the Dy content (dosage) became higher.

### Experimental Example 2

A permanent magnet alloy material was prepared by adding a powder made of TiC as a high melting point compound having the average grain size d50 of 1.04 μm, to the alloy A that was used in Experimental Example 1, so that the concentration of the high melting point compound in the permanent magnet alloy material became 0.2% by mass.

Next, an R-T-B based rare earth permanent magnet was produced by using the thus prepared permanent magnet alloy material, in the same manner as that of Experimental Example 1.

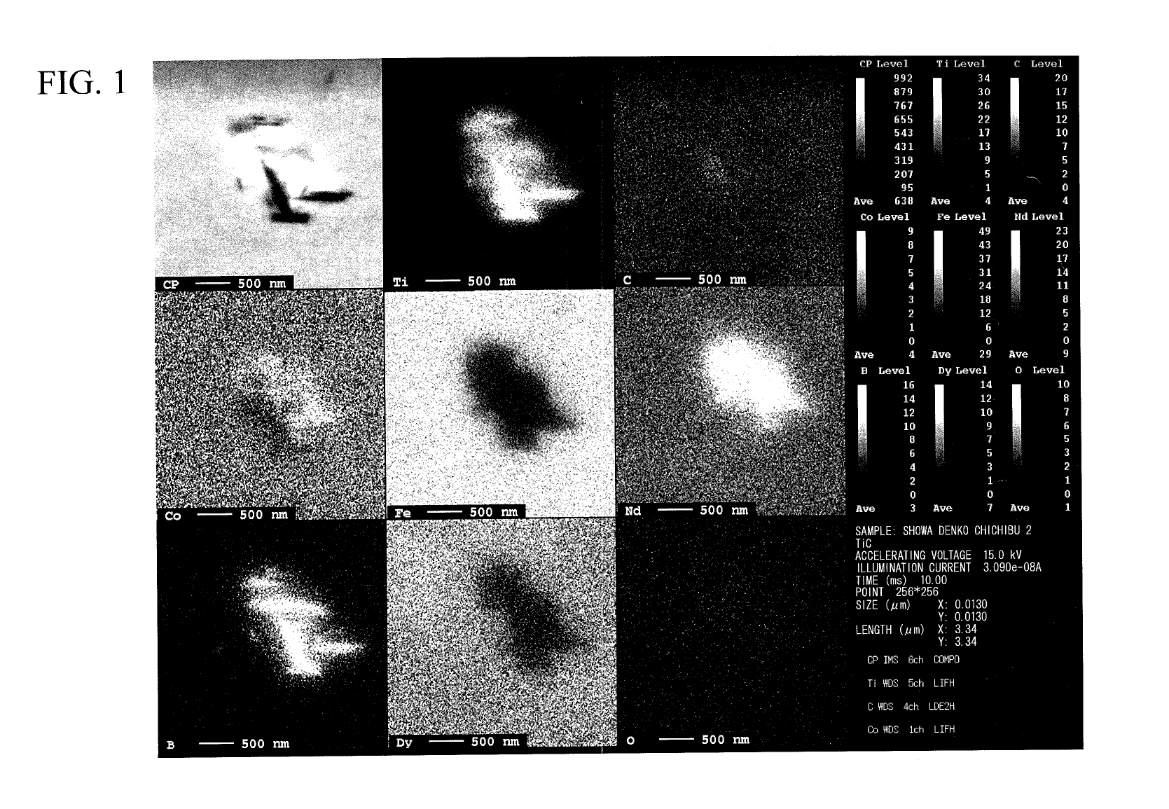

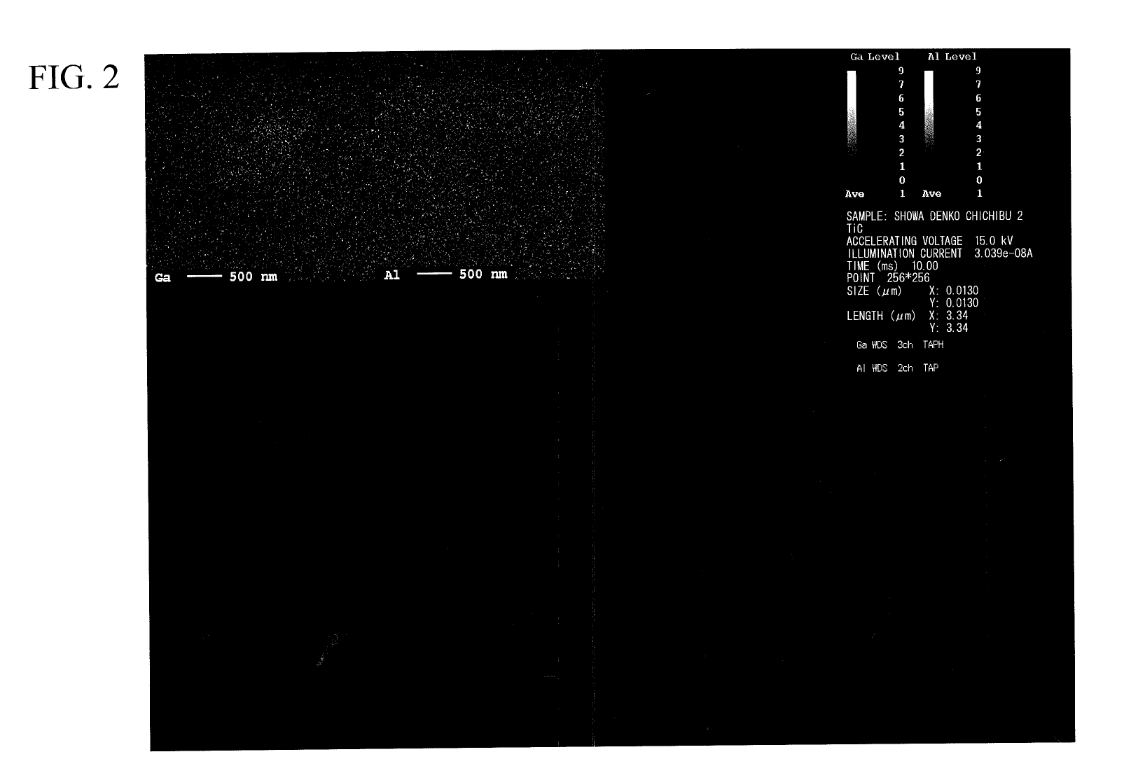

Thereafter, the produced R-T-B based rare earth permanent magnet was analyzed by an electron probe micro analyzer (EPMA). The results are shown in FIG. 1 and FIG. 2.

FIG. 1 and FIG. 2 are photographs showing the results of the R-T-B based rare earth permanent magnet analyzed by the electron probe micro analyzer. In FIG. 1 and FIG. 2, the detection results of a variety of elements are shown. FIG. 1 shows that Ti and B were detected in the same area while C was not detected. These results confirmed that TiC that had been included in the high melting point compound was present in the form of TiB₂ within the grain boundary. It is considered that TiB₂ was produced by the reaction of TiC that had been included in the high melting point compound with B in the material of the R-T-B based rare earth permanent magnet, during the sintering process.

1. An alloy material for an R-T-B based rare earth permanent magnet, comprising:
an R-T-B based alloy that comprises R, T, and B (wherein R represents at least one selected from the group consisting of Nd, Pr, Dy, and Tb, with Dy or Tb being essentially contained at 4% by mass to 10% by mass in the R-T-B type alloy; T represents a transition metal which essentially contains Fe; and B represents boron, a part of which can be substituted by carbon or nitrogen); and
a high melting point compound having a melting point of 1080° C. or higher.

2. An alloy material for an R-T-B based rare earth permanent magnet according to claim 1, wherein the high melting point compound includes an oxide, a boride, a carbide, a nitride, or a silicide of any one selected from the group consisting of Al, Ga, Mg, Nb, Si, Ti, and Zr.

3. An alloy material for an R-T-B based rare earth permanent magnet according to claim 1, wherein the high melting point compound includes any one selected from the group consisting of AlN, Al₂O₃, BN, Ga₂O₃, LaSi₂, MgO, NbB₂, NbO₂, SiC, TiO₂, TiB₂, TiC, TiN, ZrO₂, ZrN, ZrC, and ZrB₂.

4. An alloy material for an R-T-B based rare earth permanent magnet according to claim 1, wherein the high melting point compound is contained at 0.002% by mass to 2% by mass.

5. An alloy material for an R-T-B based rare earth permanent magnet according to claim 1, which is a mixture of a powder made of the R-T-B type alloy and a powder made of the high melting point compound.

6. A process for producing an R-T-B based rare earth permanent magnet, comprising molding and sintering the alloy material for an R-T-B based rare earth permanent magnet according to claim 1.

7. A motor comprising an R-T-B based rare earth permanent magnet that has been produced by the process for producing an R-T-B based rare earth permanent magnet according to claim 6.
